(19) United States
(12) Patent Application Publication
(10) Pub. No.: US 2023/0013705 A1
(43) Pub. Date: Jan. 19, 2023

(54) SILYLATED POLYMER-BASED MOISTURE-CROSSLINKABLE COMPOSITION

(71) Applicant: BOSTIK SA, Colombes (FR)

(72) Inventor: Federico SANZ, Venette (FR)

(21) Appl. No.: 17/778,065

(22) PCT Filed: Nov. 19, 2020
(86) PCT No.: PCT/FR2020/052133

§ 371 Date: May 19, 2022

(30) Foreign Application Priority Data
Nov. 21, 2019 (FR) FR1913025

(51) Int. Cl. C08G 77/46; C08K 3/26; C09D 183/12; C09D 7/61; C09J 183/12; C09J 11/04; C09K 3/10

(52) U.S. Cl. CPC C08G 77/46; C08K 3/26; C09D 183/12; C09D 7/61; C09J 183/12; C09J 11/04; C09K 3/1018; C09K 2200/0685; C09K 2200/0239

(57) ABSTRACT

The present invention relates to a moisture-crosslinkable composition comprising:
at least one polymer (A) comprising at least one alkoxysilane group;
at least 25% by weight of at least one carbonate filler (B) relative to the total weight of said composition;
at least one compound chosen from bis(alkoxysilane)s or tri(alkoxysilane)s (C) having a molar mass ranging from 250 to 1000 g/mol;
at least one crosslinking catalyst (D);
   said composition being characterized in that it comprises a plasticizer content of less than or equal to 1% by weight relative to the total weight of the composition.

### FIELD OF THE INVENTION

The present invention relates to a silylated polymer-based moisture-crosslinkable composition.

The present invention also relates to the use of said composition as an adhesive, coating or sealant.

### TECHNOLOGICAL BACKGROUND

In the motor vehicle field, adhesive compositions are widely used, whether for attaching movable panels such as doors, hoods, etc., or else for attaching windshields.

The adhesive used for windshields must perform several functions, namely: have sufficient adhesion to the seal/windscreen interface, but also good impermeability with respect to the outside conditions (water, temperature, moisture, etc.).

In the adhesives field, silane-modified polymers (“SMPs”) are widely used. However, these adhesives can have the drawback of resulting in adhesive seals which exhibit a loss of their adhesive properties under stringent climatic conditions.

There is therefore a need for new compositions resulting in an adhesive seal which exhibits a balance between good adhesion properties and good resistance to aging, in particular under stringent temperature and moisture conditions.

### DESCRIPTION OF THE INVENTION

### Composition

The present invention relates to a moisture-crosslinkable composition comprising:
at least one polymer (A) comprising at least one alkoxysilane group;
at least 25% by weight of at least one carbonate filler (B) relative to the total weight of said composition;
at least one compound chosen from bis(alkoxysilane)s or tri(alkoxysilane)s (C) having a molar mass ranging from 250 to 1000 g/mol;
at least one crosslinking catalyst (D);
   said composition being characterized in that it comprises a plasticizer content of less than or equal to 1% by weight relative to the total weight of the composition.

Preferably, the plasticizer content is less than or equal to 0.5%, preferentially less than or equal to 0.1%, and even more preferentially the plasticizer content is equal to zero.

Plasticizers represent a class of compounds well known to those skilled in the art, in particular in the field of adhesive, coating or sealant compositions. Mention may in particular be made of phthalates, such as dibutyl phthalate, diisononyl phthalate or diisodecyl phthalate; diisononyl 1,2-cyclohexanedicarboxylate (Hexamoll DINCH available from BASF); unsaturated fatty acid esters (for example butyl oleate); alkylsulfonic esters (such as Mesamoll from Lanxess); phosphate compounds; trimellitate compounds; hydrocarbon oils; epoxy plasticizers; etc.

It has in fact been found that the composition which is the subject of the invention advantageously makes it possible to obtain, after crosslinking, an adhesive seal which has good mechanical properties and has good resistance to aging, in particular under stringent temperature and moisture conditions.

Polymer (A) Comprising at Least One Alkoxysilane Group

According to one embodiment, the polymer (A) comprising at least one alkoxysilane group is a polymer comprising at least one, preferably at least two, groups of formula (I):

—Si(R⁴)ₚ(OR⁵₃₋ₚ (I)

wherein:
R⁴ represents a linear or branched alkyl radical comprising from 1 to 4 carbon atoms, or an alkoxy group comprising from 1 to 4 carbon atoms;
R⁵ represents a linear or branched alkyl radical comprising from 1 to 4 carbon atoms or a group —N═C(Rⁱ)R^{j} wherein:
   Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   or Rⁱ and R^{j} together form an aliphatic ring comprising from 3 to 14 carbon atoms, preferably from 4 to 8 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom, said nitrogen atom then not being bonded to a hydrogen atom;

p is an integer equal to 0, 1 or 2.

Preferably, the group(s) of formula (1) are groups located at the ends of the main chain of the polymer, also known as end groups.

Preferably, the polymers (A) comprising at least one alkoxysilane group are chosen from polyurethanes, polyethers and mixtures thereof.

The polymer (A) comprising at least one alkoxysilane group can exhibit a number-average molecular weight ranging from 500 to 50 000 g/mol, more preferably ranging from 700 to 20 000 g/mol.

The number-average molecular weight of the polymers can be measured by methods well known to those skilled in the art, for example by size exclusion chromatography using standards of polyethylene glycol type.

According to one embodiment, the silylated polymer comprising at least one alkoxysilane group is chosen from the polymers of formulae (II), (III) or (IV) as defined below, and mixtures thereof:

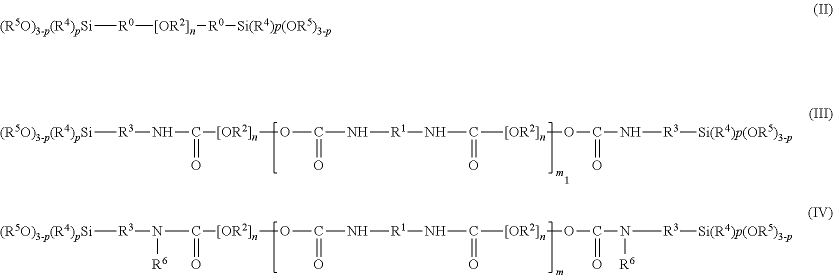

wherein:
R¹ represents a divalent hydrocarbon-based radical comprising from 5 to 15 carbon atoms which can be aromatic or aliphatic and linear, branched or cyclic,
R⁰ represents a linear or branched divalent alkylene radical comprising from 3 to 6 carbon atoms,
R³ represents a linear or branched divalent alkylene radical comprising from 1 to 6 carbon atoms, R³ preferably representing methylene or n-propylene,
R² represents a linear or branched divalent alkylene radical comprising from 2 to 14 carbon atoms, preferably from 2 to 6 carbon atoms, and even more preferentially from 2 to 4 carbon atoms,
R⁴ represents a linear or branched alkyl radical comprising from 1 to 4 carbon atoms, or an alkoxy group comprising from 1 to 4 carbon atoms;
R⁵ represents a linear or branched alkyl radical comprising from 1 to 4 carbon atoms or a group —N═C(Rⁱ)R^{j} wherein:
   Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   or Rⁱ and R^{j} together form an aliphatic ring comprising from 3 to 14 carbon atoms, preferably from 4 to 8 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom, said nitrogen atom then not being bonded to a hydrogen atom;
R⁶ represents a hydrogen atom, a phenyl radical, a linear, branched or cyclic alkyl radical comprising from 1 to 6 carbon atoms, or a 2-succinate radical of formula:

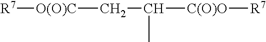

wherein R⁷ is a linear or branched alkyl radical comprising from 1 to 6 carbon atoms,
n is an integer such that the number-average molecular weight of the polyether block of formula —[OR²]ₙ— ranges from 300 g/mol to 40 000 g/mol in the polymers of formulae (II), (III) and (IV),
m₁ is zero or an integer,

n and m₁ are such that the number-average molecular weight of the polymer of formula (III) ranges from 500 g/mol to 50 000 g/mol, preferably from 700 g/mol to 20 000 g/mol,
m is an integer other than zero,
n and m are such that the number-average molecular weight of the polymer of formula (IV) ranges from 500 g/mol to 50 000 g/mol, preferably from 700 g/mol to 20 000 g/mol,
p is an integer equal to 0, 1 or 2, p preferably being 0 or 1.

Preferably, the R¹ radical of the formulae (II), (III) and (IV) is chosen from one of the following divalent radicals, the formulae of which below show the two free valencies:
a) the divalent radical derived from isophorone diisocyanate (IPDI):

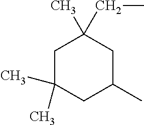

b) the divalent radical derived from dicyclohexylmethane-4,4′- and 2,4′-diisocyanate (HMDI):

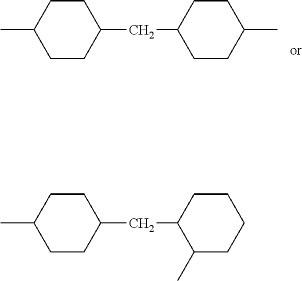

c) the radical derived from toluene-2,4- and 2,6-diisocyanate (TDI):

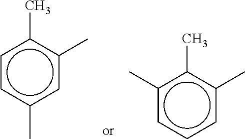

d) the radical derived from diphenylmethane-4,4′- and 2,4′-diisocyanate (MDI):

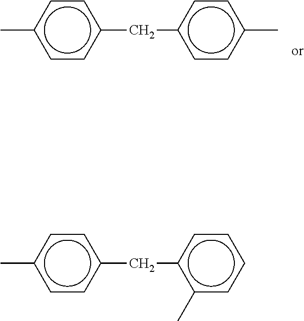

e) the radical derived from m-xylylene diisocyanate (m-XDI):

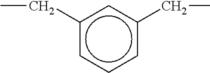

f) the radical derived from hexamethylene diisocyanate (HDI):

—(CH₂)₆—
g) the radical derived from an HDI allophanate having formula (Y) below:

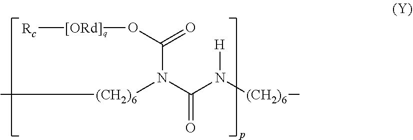

wherein p is an integer ranging from 1 to 2, q is an integer ranging from 0 to 9 and preferably from 2 to 5, R_{c} represents a saturated or unsaturated, cyclic or acyclic, linear or branched, hydrocarbon-based chain comprising from 1 to 20 carbon atoms, preferably from 6 to 14 carbon atoms, and R_{d} represents a linear or branched divalent alkylene group having from 2 to 4 carbon atoms, and preferably a divalent propylene group.

Preferably, the R¹ radical of the formulae (II), (III) and (IV) is the divalent radical derived from isophorone diisocyanate or from xylylene diisocyanate.

The polymers of formula (III) can be obtained according to a process described in documents EP 2 336 208 and WO 2009/106699.

Mention may be made, among the polymers corresponding to the formula (III), for example, of:
Geniosil® STP-E10 (available from Wacker): polyether comprising two groups (I) of dimethoxy type (m₁ equal to 0, p equal to 1 and R⁴ and R⁵ represent a methyl group) having a number-average molecular weight of about 8889 g/mol where R³ represents a methylene group;
Geniosil® STP-E30 (available from Wacker): polyether comprising two groups (I) of dimethoxy type (mi equal to 0, p equal to 1 and R⁴ and R⁵ represent a methyl group) having a number-average molecular weight of about 14 493 g/mol where R³ represents a methylene group;
Spur+® 1050MM (available from Momentive): polyurethane comprising two groups of formula (I) of trimethoxy type (m₁ other than 0, p equal to 0 and R⁵ represents a methyl group) exhibiting a number-average molecular weight of approximately 21 000 g/mol where R³ represents an n-propylene group;
Spur+® Y-19116 (available from Momentive): polyurethane comprising two groups of formula (I) of trimethoxy type (m₁ other than 0 and R⁵ represents a methyl group) exhibiting a number-average molecular weight ranging from 15 000 to 17 000 g/mol where R³ represents an n-propylene group;
Desmoseal® S XP 2636 (available from Bayer): polyurethane comprising two groups of formula (I) of trimethoxy type (m₁ other than 0, p equal to 0 and R⁵ represents a methyl group) exhibiting a number-average molecular weight of approximately 15 038 g/mol where R³ represents an n-propylene group.

Mention may also be made, by way of example of silylated polymer of formula (III), of Geniosil® XB502, a commercial product available from Wacker. This product Geniosil® XB502 comprises a mixture of two products (B) and (C), where
(B) is a polymer of formula (III) with a number-average molecular weight of approximately 14 000 g/mol where m₁ is equal to zero, p is equal to 1, R⁵ and R⁴ each represent a methyl group, R³ represents a methylene group and the —[OR²]ₙ— group originates from a polypropylene glycol;
(C) is a silsesquioxane (A) with a number-average molecular weight of approximately 800 g/mol terminated by methoxy groups (CAS 1211908-05-2),

the products (B) and (C) being present in a (B)/(C) ratio by weight of approximately (25-30)/(70-75).

The polymers of formula (II) can be obtained by hydrosilylation of polyether diallyl ether according to a process described, for example, in document EP 1 829 928.

Among the polymers corresponding to formula (II), mention may be made of:

MS Polymer™ 5303H (available from Kaneka), corresponding to a polyether comprising two groups of formula (I) of dimethoxy type (p is equal to 1 and R⁴ represents a methyl group) having a number-average molecular weight of approximately 22 000 g/mol and a viscosity of 12.5 Pa·s at 23° C.;

MS Polymer™ S227 (available from Kaneka), corresponding to a polyether comprising two groups of formula (I) of dimethoxy type (p equal to 1 and R⁵ and R⁴ each represent a methyl group) having a number-average molecular weight of about 27 000 g/mol and a viscosity of 34 Pa·s at 23° C.

The polymers of formula (IV) can be obtained according to the following process:
a)reaction of a polyether polyol of following formula:

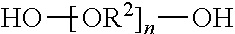

with a stoichiometric excess of diisocyanate of following formula: NCO—R¹—NCO in order to form a polyurethane-polyether block having at least two —NCO end groups, said block preferably comprising from 1.5% to 1.9% by weight of —NCO groups, and then
b)reaction between a block obtained in the preceding step with a stoichiometric amount or a slight excess of an α-, β- or γ-aminosilane having the following formula:

(R⁵O)₃₋ₚ(R⁴)ₚSi—R³—NHR⁵

Such a process is described, for example, in WO 2013/136108.

Mention may be made, among the polymers corresponding to the formula (IV), of:
Spur+ 1050 MM (available from Momentive), corresponding to a polyurethane polyether comprising two groups of formula (I) of trimethoxy type (p is equal to 0 and R⁵ represents a methyl group) having a number-average molecular weight of approximately 20 000 g/mol and a viscosity of 35 Pa·s at 23° C.;
Spur+ 1015 LM (available from Momentive), corresponding to a polyurethane polyether comprising two groups of formula (I) of trimethoxy type (p is equal to 0 and R⁵ represents a methyl group) having a number-average molecular weight of approximately 25 000 g/mol and a viscosity of 50 Pa·s at 23° C.

According to one embodiment, the composition according to the invention comprises from 3% to 80% by weight, preferably from 10% to 60% by weight, preferentially from 20% to 60% by weight, advantageously from 30% to 60% by weight of silylated polymer(s) (A) relative to the total weight of said composition.

According to one preferred embodiment, the silylated polymer has the abovementioned formula (II), in particular wherein:
p is equal to 1; and/or
R⁴ represents a methyl.

Carbonate Filler (B)

According to one embodiment, the carbonate filler is chosen from alkali metal or alkaline-earth metal carbonates and mixtures thereof; preferably, the carbonate filler is calcium carbonate.

The calcium carbonate can be rendered hydrophobic, for example with calcium stearate or an analog, making it possible to confer a partial or complete hydrophobicity on the calcium carbonate particles. The more or less hydrophobic character of calcium carbonate can have an impact on the rheology of the composition. Moreover, the hydrophobic coating can make it possible to prevent the calcium carbonate from absorbing the constituents of the composition and from rendering them ineffective. The hydrophobic coating of the calcium carbonate can represent from 0.1% to 3.5% by weight, relative to the total weight of calcium carbonate.

The calcium carbonate which can be used in the present invention preferably has a particle size ranging from 0.1 to 400 μm, more preferably from 1 to 400 μm, preferentially from 10 to 350 μm, more preferably from 50 to 300 μm.

Mention may be made, by way of example of calcium carbonate, of Mikhart® 1T (available from La Provençale).

The composition according to the invention comprises at least 25% by weight of at least one carbonate filler, preferably at least 30% by weight, preferentially at least 40% by weight, relative to the total weight of the composition.

The composition according to the invention preferably comprises from 25% to 70% by weight, preferentially from 40% to 60% by weight, in particular from 45% to 55% by weight, of at least one carbonate filler, for example calcium carbonate, relative to the total weight of said composition.

The composition may comprise from 0.01 to 20 parts by weight of bis(alkoxysilane)(s) or tri(alkoxysilane)(s) (C) per 100 parts of polymer(s) (A), preferably from 0.1 to 10 parts by weight of bis(alkoxysilane)(s) or tri(alkoxysilane)(s) (C) per 100 parts of polymers(s) (A), and even more preferentially from 1 to 5 parts by weight of bis(alkoxysilane)(s) or tri(alkoxysilane)(s) (C) per 100 parts of polymer(s) (A).

Bis(Alkoxysilane) or Tri(Alkoxysilane) (C)

The bis(alkoxysilane) or tri(alkoxysilane) (C) may have the following formula (V):

R⁸—[SiR⁹ₜ(OR¹⁰)₃₋ₜ]ₛ (V)

wherein:
t represents an integer equal to 0, 1 or 2;
s represents an integer equal to 2 or 3;
R⁸ represents an organic radical:
R⁹, which may be identical or different, each represent a linear or branched C₁-C₆ alkyl group, or an —OR¹¹ group with R¹¹ representing a linear or branched C₁-C₄ alkyl group;
R¹⁰, which may be identical or different, each represent a linear or branched alkyl radical comprising from 1 to 4 carbon atoms or an —N═C(Rⁱ)Rⁱ group wherein:
   Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   R is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   or Rⁱ and Rⁱ together form an aliphatic ring comprising from 3 to 14 carbon atoms, preferably from 4 to 8 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom, said nitrogen atom then not being bonded to a hydrogen atom.

According to one preferred embodiment, bis(alkoxysilane) or tri(alkoxysilane) (C) has a molar mass ranging from 270 to 1000 g/mol, preferably from 270 to 750 g/mol, preferentially from 270 to 600 g/mol.

According to one embodiment, the bis(alkoxysilane) or tri(alkoxysilane) (C) has either of the following formulae (V-A) or (V-B):

(R¹⁰O)₃₋ₜR⁹ₜSi—R¹²—SiR⁹ₜ(OR¹⁰)₃₋ₜ (V-A)

R¹³—[SiR⁹ₜ(OR¹⁰)₃₋ₜ]₃ (V-B)

wherein:
R⁹, R¹⁰ and t are as defined above;
R¹² represents an oxygen atom, a linear or branched C₁-C₁₂ alkylene radical, a C₆-C₁₂ arylene radical, or a linear or branched C₂-C₁₂ alkenylene radical, said alkylene and alkenylene radicals optionally comprising one or more radicals chosen from —O—, —S—, —NR— with R representing H or a group that is alkyl, —C(═O)—O— or —O—C(═O), —C(O)—NR′— or —NR′—C(═O) with R′ representing H or a group that is alkyl, —O—C(═O)—NH— or —NH—C(═O)—O— or uretdione;
R¹³ represents a radical:

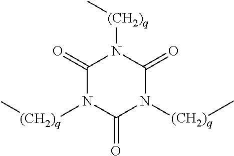

with q representing an integer ranging from 1 to 10.

The compounds of formula (V-B) are preferably those wherein:
q ranges from 1 to 3;
R⁹, which may be identical or different, each represent an —OR¹¹ group with R¹¹ representing a linear or branched C₁-C₄ alkyl group.

Preferably, the compounds of formula (V-B) are chosen from the following compounds:

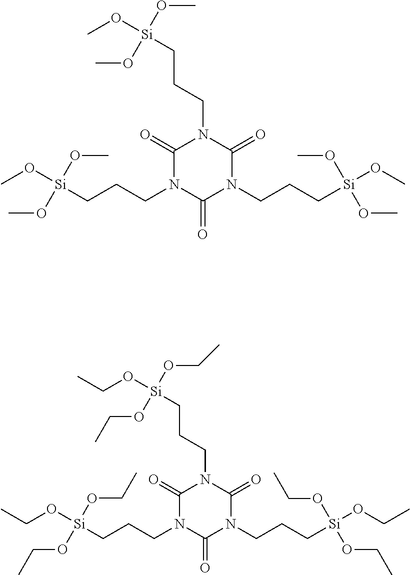

The compounds of formula (V-A) are preferably those wherein:
R¹² represents an oxygen atom, a linear or branched C₁-C₈ alkylene radical, or a C₂-C₈ alkenylene radical, said alkylene and alkenylene radicals optionally comprising one or more radicals chosen from —O—, —S—, —NR— with R representing H or a group that is alkyl, —C(O)—NR′— or —NR′—C(═O) with R′ representing H or a group that is alkyl, —O—C(═O)—NH— or —NH—C(═O)—O— or uretdione;
R¹⁰, which may be identical or different, each represent a linear or branched alkyl radical comprising from 1 to 4 carbon atoms or an —N═C(Rⁱ)Rⁱ group wherein:
   Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   or Rⁱ and R^{j} together form an aliphatic ring comprising from 3 to 14 carbon atoms, preferably from 4 to 8 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom, said nitrogen atom then not being bonded to a hydrogen atom;
R⁹, which may be identical or different, each represent a linear or branched C₁-C₆ alkyl group, or an —OR¹¹ group with R¹¹ representing a linear or branched C₁-C₄ alkyl group; and
t represents a number equal to 0, 1 or 2.

Even more preferably, the compounds of formula (V-A) are those wherein:
R¹² represents an oxygen atom, a linear or branched C₁-C₈ alkylene radical, or a C₂-C₈ alkenylene radical, said alkylene and alkenylene radicals optionally comprising one or more radicals chosen from —O—, —S—, —NR— with R representing H or a group that is alkyl, —C(O)—NR′— or —NR′—C(═O) with R′ representing H or a group that is alkyl, —O—C(═O)—NH— or —NH—C(═O)—O— or uretdione;
R¹⁰, which may be identical or different, each represent a linear or branched alkyl radical comprising from 1 to 4 carbon atoms,
R⁹, which may be identical or different, each represent a linear or branched C₁-C₆ alkyl group, or an —OR¹¹ group with R¹¹ representing a linear or branched C₁-C₄ alkyl group; and
t represents a number equal to 0, 1 or 2.

Preferably, the compounds of formula (V-A) are chosen from the group consisting of:

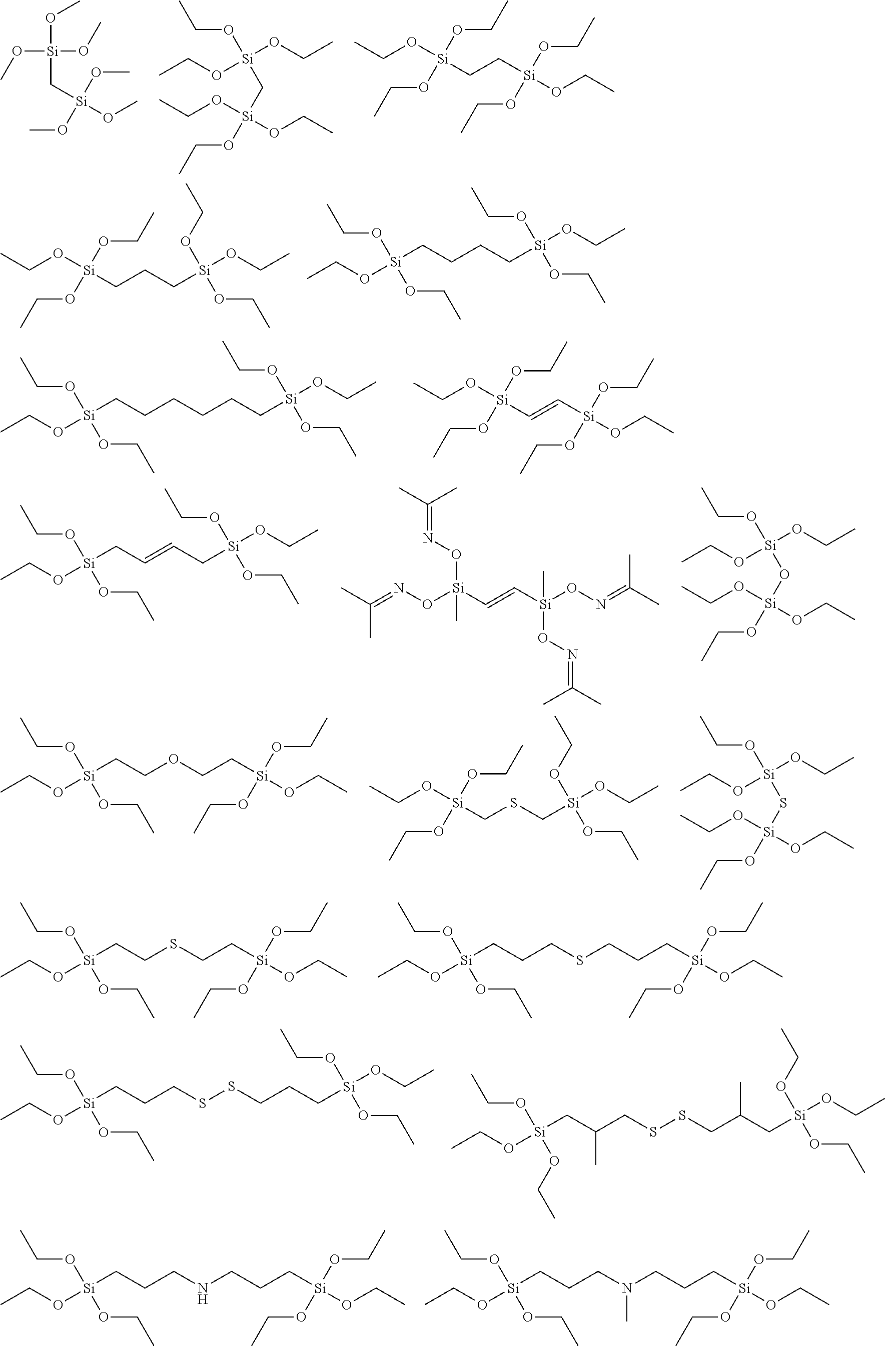

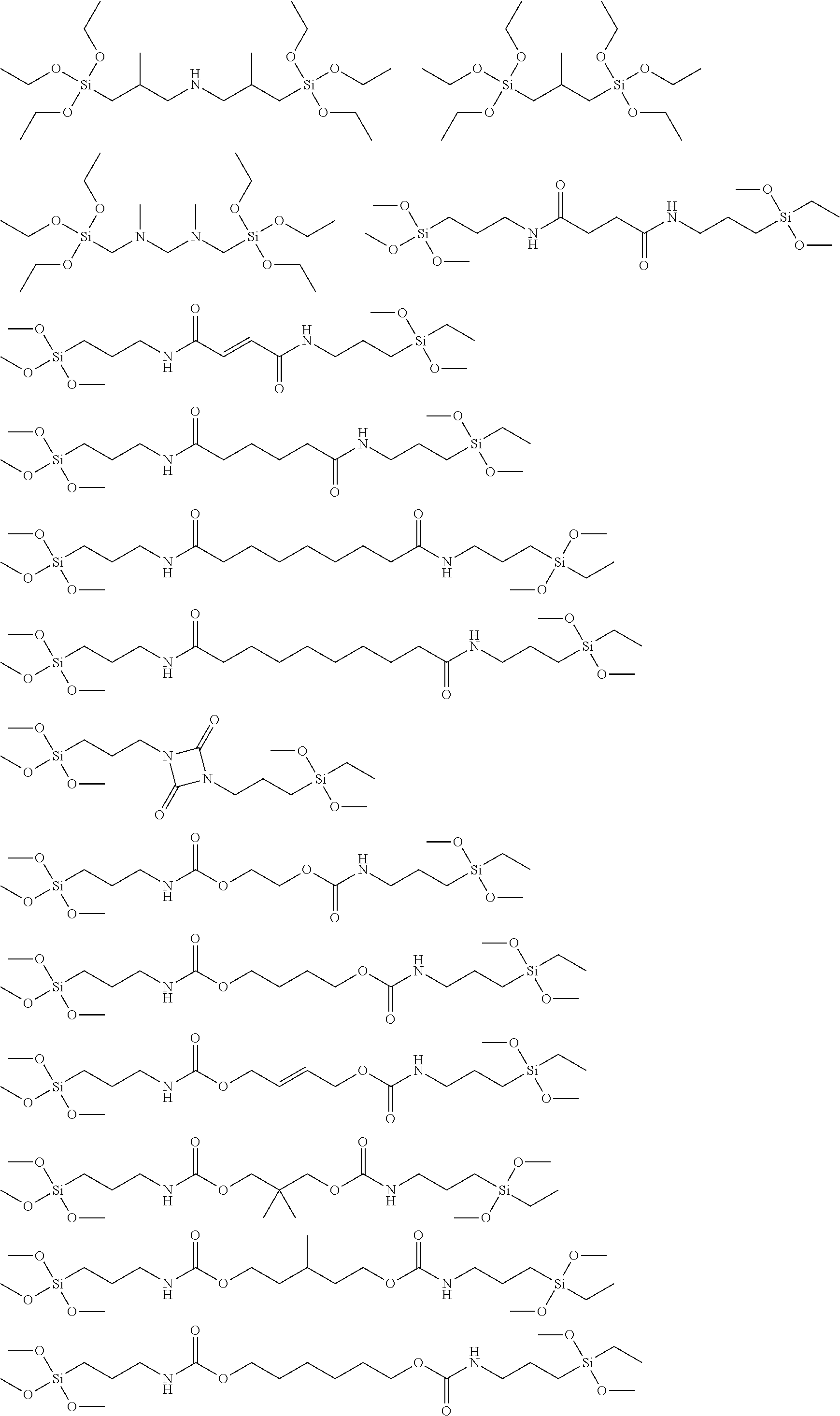

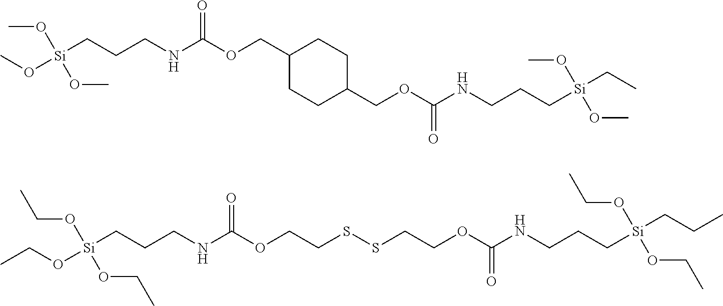

The bis(alkoxysilane) or tri(alkoxysilane) (C) is preferably a compound of formula (V-A), and in particular 1,2-bis(triethoxysilyl)ethane.

The composition can comprise a total content of bis(alkoxysilane)(s) or tri(alkoxysilane)(s) (C) ranging from 0.1% to 20% by weight, preferably from 0.2% to 10% by weight, preferentially from 0.5% to 5% by weight, and even more advantageously from 1% to 3% by weight relative to the total weight of the composition.

Crosslinking Catalyst (D)

The catalyst (D) can be any catalyst known to those skilled in the art for the condensation of silanol. Mention may be made, as examples of such catalysts, of:
aminosilanes, such as N-(2-aminoethyl)-3-aminopropyltrimethoxysilane (commercially available under the name Silquest® A-1120 from Momentive) or 3-aminopropyltrimethoxysilane,
organotitanium derivatives, such as titanium acetylacetonate (commercially available under the name Tyzor® AA75 from DuPont de Nemours),
aluminum, such as aluminum chelate (commercially available under the name K-KAT® 5218 from King Industries),
amines, such as 1 ,8-diazabicyclo[5.4.0] undec-7-ene (DBU) or 1,5-diazabicyclo[4.3.0]non-5-ene (DBN), 2,2′-dimorpholinodiethyl ether (DMDEE) or 1,4-diazabicyclo[2.2.2]octane (DABCO),
tin-based catalysts, such as, for example, Neostann® S-1 or TIB-KAT® 216 (respectively available from Kaneka or TIB Chemicals). These tin-based catalysts are particularly suitable for silylated polymers of formula (II).

The catalyst(s) (D) preferably represent from 0.01% to 1% by weight, preferentially from 0.05% to 0.6% by weight, advantageously from 0.1% to 0.6% by weight, of the total weight of the composition.

Composition

According to a preferred embodiment, the composition comprises:
from 10% to 60% by weight of polymer(s) (A) comprising at least one alkoxysilane group;
from 25% to 70% by weight of carbonate filler(s) (B);
from 0.01% to 5% by weight of bis(alkoxysilane)(s) or tri(alkoxysilane)(s) (C) having a molar mass ranging from 250 to 1000 g/mol;
from 0.01% to 1% by weight of crosslinking catalyst(s) (D);
the percentages being expressed by weight relative to the total weight of said composition.

According to one embodiment, the composition also comprises at least one additive chosen from the group consisting of solvents, pigments, adhesion promoters, moisture absorbers, UV stabilizers, rheological agents, fillers other than carbonate fillers, and mixtures thereof.

In the context of the invention, “filler other than the carbonate filler” or also “filler” is understood to mean a filler which is not a carbonate filler.
The filler can be chosen from organic fillers, inorganic fillers and mixtures thereof.

Use may be made, as organic filler(s), of any organic filler(s) and in particular polymeric filler typically used in the field of sealant compositions.

Use may be made, for example, of polyvinyl chloride (PVC), polyolefins, rubber, ethylene/vinyl acetate (EVA) or aramid fibers, such as Kevlar®.

Use may also be made of expandable or non-expandable hollow microspheres made of thermoplastic polymer. Mention may notably be made of hollow microspheres made of vinylidene chloride/acrylonitrile. The mean particle size of the filler(s) which can be used is preferably less than or equal to 10 microns, more preferentially less than or equal to 3 microns, in order to prevent them from settling in the composition according to the invention during its storage.

The mean particle size is measured for a volume particle size distribution corresponding to 50% by volume of the sample of particles which is analyzed. When the particles are spherical, the mean particle size corresponds to the median diameter (D50 or Dv50), which corresponds to the diameter such that 50% of the particles by volume have a size which is smaller than said diameter. In the present application, this value is expressed in micrometers and determined according to standard NF ISO 13320-1 (1999) by laser diffraction on an appliance of Malvern type.

Preferably, the filler is an inorganic filler.

The inorganic fillers can be provided in the form of particles of diverse geometry. They can, for example, be spherical or fibrous or exhibit an irregular shape.

According to one embodiment, the filler is chosen from sand, glass beads, glass, quartz, barite, alumina, mica or talc. Preferably, the filler is chosen from sand and glass beads.

The sand which can be used in the present invention preferably has a particle size ranging from 0.1 to 400 μm, preferentially from 1 to 400 μm, more preferably from 10 to 350 μm, more preferably from 50 to 300 μm.

The glass beads which can be used in the present invention preferably have a particle size ranging from 0.1 to 400 μm, preferentially from 1 to 400 μm, more preferably from 10 to 350 μm, more preferably from 50 to 300 μm.

The composition according to the invention can comprise at least one rheological agent.

Mention may be made, by way of example of rheological agent(s) which can be used, of any rheological agent generally used in the field of sealant compositions.

Preferably, use is made of one or more rheological agents chosen from thixotropic agents, and more preferably from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica,
urea derivatives resulting from the reaction of an aromatic diisocyanate monomer, such as 4,4′-MDI, with an aliphatic amine, such as butylamine. The preparation of such urea derivatives is described in particular in the application FR 1 591 172.
micronized amide waxes, such as Crayvallac SLX sold by Arkema.

The total content of rheological agent(s) which can be used can vary from 1% to 30% by weight, preferably from 5% to 30% by weight, more preferably from 10% to 25% by weight, relative to the total weight of the composition according to the invention.

The solvent is preferably a solvent which is volatile at ambient temperature (temperature of the order of 23° C.). The volatile solvent may, for example, be chosen from alcohols which are volatile at ambient temperature, such as ethanol or isopropanol. The volatile solvent makes it possible, for example, to reduce the viscosity of the composition and make the composition easier to apply. The volatile character of the solvent makes it possible for the seal, obtained after curing the composition, to no longer contain solvent. Thus, the solvent has, for example, no negative influence on the hardness of the seal.

When a solvent, in particular a volatile solvent, is present in the composition, its content is preferably less than or equal to 5% by weight, more preferably less than or equal to 3% by weight, relative to the total weight of the composition.

Preferably, the content of solvent(s) in the composition is between 0% and 5% by weight.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight of the total weight of the composition.

The pigments can be organic or inorganic pigments.

For example, the pigment is TiO₂, in particular Kronos® 2059 sold by Kronos.

The moisture absorber, if it is present, can be chosen from vinyltrimethoxysilane (VTMO), vinyltriethoxysilane (VTEO) or alkoxyarylsilanes, such as Geniosil® XL 70 available from Wacker.

When a moisture absorber is present in the composition, its content is preferably less than or equal to 3% by weight, more preferably less than or equal to 2% by weight, relative to the total weight of the composition. When it is present, the moisture absorber can, for example, represent from 0.5% to 3% by weight or from 1% to 2% by weight, relative to the total weight of the composition.

Mention may be made, among UV stabilizers, of benzotriazoles, benzophenones, “hindered” amines, such as bis(2,2,6,6-tetramethyl-4-piperidyl) sebacate, and mixtures thereof.

Mention may be made, for example, of the products Tinuvin® 328 or Tinuvin™ 770, sold by BASF.

The composition according to the invention can be in the one-component form, that is to say that all the components are packaged in one and the same compartment.

The composition is preferably ready-for-use, that is to say that the user (private individual or professional) can directly apply the composition in order to produce the seal, without having to carry out premixing.

The composition can be prepared by mixing the polymer(s) (A) and the filler(s) (carbonate and other fillers) at a temperature ranging from 5° C. to 80° C., preferably under an inert atmosphere. The catalyst or catalysts can be added at the same time or in a second step after mixing the polymer(s) and the filler(s). The compound (C) can also be added at the same time or in a second step after mixing the polymer(s) and the filler(s). The other additives are introduced into the composition in accordance with the normal usages.

The compositions according to the invention comprise a moisture-crosslinkable polymer (A), the chemical structure of which has end reactive groups of alkoxysilane type, and also a compound (C) comprising reactive groups. The reaction of all these reactive groups with the water originating from the moisture of the air or of the substrate (known as crosslinking reaction) makes possible in particular, after the introduction of the sealant into the gap between the two substrates to be assembled, the creation of a solid three-dimensional polymeric network which confers the desired mechanical properties on the adhesive seal thus created.

This reaction, referred to as crosslinking reaction, results, once it is complete, in the formation of an adhesive seal between the two substrates which is constituted by the polymer and the compound (C), which are crosslinked to give a three-dimensional network formed by the polymer chains connected together via bonds of siloxane type. This seal ensures in particular the solidity of the assembly of the two substrates thus obtained.

The composition according to the invention advantageously exhibits good resistance to aging after crosslinking. In particular, the composition advantageously exhibits a heightened resistance to wet poultice.

Resistance to aging is in particular tested using the wet poultice test according to the conditions of standard NF EN ISO 9142 of January 2004, annex E, procedure E2 (exposure time in the chamber A=14 days). This test makes it possible in particular to verify the assembly reliability under stringent climatic conditions.

### Uses

The present invention relates to the use of the composition as defined above as an adhesive, sealant or coating, preferably as an industrial sealant.

The composition can in particular serve as an adhesive and sealant in the motor vehicle field, for example for attaching motorcar windshields, as metallic seal.

The present invention also relates to the use of a compound (C) chosen from bis(alkoxysilane)s and tri(alkoxysilane)s having a molar mass ranging from 250 to 1000 g/mol in a composition comprising:
at least one polymer (A) comprising at least one alkoxysilane group;
at least 25% by weight of a carbonate filler (B) relative to the total weight of said composition;
for improving the resistance to aging of the composition after crosslinking.

The ingredients and characteristics described above for the composition also apply for the abovementioned use.

In the context of the invention, the term “between x and y” or “ranging from x to y” means a range wherein the limits x and y are included. For example, the range “between 1% and 10%” notably includes the values 1% and 10%.

The following examples illustrate the invention without, however, limiting it.

Experimental Section
The following products were used in the manufacture of the sealant compositions according to the invention:
   MS Polymer® S 303 (available from Kaneka) (silylated polyether polymer having an Mn of 21 000-23 000 Daltons;
   Dynasylan BTSE® (CAS: 16068-37-4) available from Evonik: 1,2-bis(triethoxysilyl)ethane, density 0.95 g/cm³;
   Tinuvin™ 770: antioxidant of bis(2,2,6,6-tetramethyl-4-piperidinyl) sebacate type, available from BASF;
   Dynasylan® VTMO: vinyltrimethoxysilane moisture absorber, available from Evonik;
   TiO2 sold by Kronos;
   Calofort S sold by Speciality Minerals;
   Ammo A 1110 sold by Momentive;
   Tibkat 226 sold by Tib Chemicals.
Compositions C1 and C2 were prepared by mixing the following ingredients according to the following procedure: mixing of the polymers, followed by addition of the fillers and pigments, and VTMO and, finally, the other ingredients and the catalyst. The entirety is mixed at a temperature of less than 70° C.

| | C1 | C2 |
|---|---|---|
| | (comparative) | (invention) |
| MS ® S 303 | 43.50 | 42.50 |
| DYNASYLAN BTSE | — | 1.00 |
| TiO₂ | 5.8 | 5.8 |
| TINUVIN ® T770 | 0.88 | 0.88 |
| Calofort S | 45.12 | 45.12 |
| AMMO A 1110 | 2.80 | 2.80 |
| VTMO | 1.40 | 1.40 |
| TIBKAT 226 | 0.50 | 0.50 |
| | 100 | 100 |

In this table 1, the proportions shown are in parts by weight.

### Properties of the Crosslinked Compositions

The properties obtained for compositions C1 and C2 after crosslinking are summarized in the following table 2:

| | C1 | C2 |
|---|---|---|
| | (comparative) | (invention) |
| Skinning time | 22 | 10 |
| (in min) | | |
| Crosslinking | 3.3 | 3 |
| after 24 h (mm) | | |
| Elongation at | 240 | 150 |
| break (in %) | | |
| maximum breaking | 3 | 3.2 |
| strength (in MPa) | | |
| Al-Al Shear | 1.57 | 1.60 |
| resistance | | |
| Al-Al Shear resistance | 0.79 | 1.52 |
| after wet poultice test | | |
| % loss of shear | 49.7 | 5 |
| resistance | | |

The skinning time was measured in a controlled atmosphere at a temperature of 20° C. and a relative humidity of approximately 60%.

The composition was applied using a wooden spatula and in the form of a thin film with a thickness of approximately 0.5 mm to a glass slide with a length of 76 mm and a width of 26 mm. Immediately after the application of said film, a stopwatch was started and it was examined every minute, using gentle pressure with the finger, if the film is dry or if a composition residue is transferred onto the finger. The skinning time is the time at the end of which the composition film is dry and for which there is no longer any transfer of adhesive residue onto the finger. The result is expressed in minutes.

The measurement of the tensile strength and the elongation at break by a tensile test was carried out according to the protocol described below.

The principle of the measurement consists in drawing, in a tensile testing device, the movable jaw of which moves at a constant rate equal to 100 mm/minute, a standard test specimen consisting of the crosslinked composition and in recording, at the moment when the test specimen breaks, the tensile stress applied (in MPa) and also the elongation of the test specimen (in %). The standard test specimen is dumbbell-shaped, as illustrated in the international standard ISO 37. The narrow part of the dumbbell used has a length of 20 mm, a width of 4 mm and a thickness of 500 μm.

The cure 24 h consists in acting on, in right-angle peeling, a flat strip of the product to be examined, of constant width and of increasing thickness. This strip was obtained by filling a calibrated trough, with a width of 10 mm and a depth varying linearly from 0 to 10 mm. The assembly was made of PTFE. After application for 24 h in a climate-controlled chamber at 23° C. and 50% RH, the level at which the product, still pasty (not polymerized over the thickness), is stuck to the assembly was recorded using graduations.

The modulus at 100% elongation was measured according to the test appearing in standard ISO11600 of 2002, which refers to standard IS08339 of 2005.

An aging test, usually called wet poultice, is a very stringent aging test for an adhesive; it is very widely used in particular by the motor vehicle industry since it guarantees assembly reliability under stringent climatic conditions. The wet poultice test was carried out according to standard NF EN ISO 9142 of January 2004, annex E, procedure E2 (exposure time in the chamber A=14 days).

In addition, composition C2 advantageously results in an adhesive seal which, after crosslinking, has good mechanical performance, including an elongation at break of greater than or equal to 150%.

The wet poultice test shows that composition C2 has not lost more than 5% of its initial properties, advantageously demonstrating a good resistance of the composition to aging under stringent temperature and moisture conditions.

1-16. (canceled)

17. A moisture-crosslinkable composition comprising:
at least one polymer (A) comprising at least one alkoxysilane group;
at least 25% by weight of at least one carbonate filler (B) relative to the total weight of said composition;
at least one compound comprising bis(alkoxysilane)s or tri(alkoxysilane)s (C) having a molar mass ranging from 250 to 1000 g/mol; and
at least one crosslinking catalyst (D);
said composition being characterized in that it comprises a plasticizer content of less than or equal to 1% by weight relative to the total weight of the composition.

18. The composition as claimed in claim 17, wherein the polymer (A) comprising at least one alkoxysilane group is a polymer comprising at least one group of formula (I):
—Si(R⁴)ₚ(OR⁵)₃₋ₚ (I)
wherein:
R⁴ represents a linear or branched alkyl radical comprising from 1 to 4 carbon atoms, or an alkoxy group comprising from 1 to 4 carbon atoms;
R⁵ represents a linear or branched alkyl radical comprising from 1 to 4 carbon atoms or a group —N═C(Rⁱ)R^{j}, wherein:
Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical; or
Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom, said nitrogen atom then not being bonded to a hydrogen atom; and
p is an integer equal to 0, 1 or 2.

19. The composition as claimed in claim 17, wherein the silylated polymer (A) comprising at least one alkoxysilane group is selected from the group consisting of polymers of formulae (II), (III) and (IV) as defined below, and mixtures thereof: 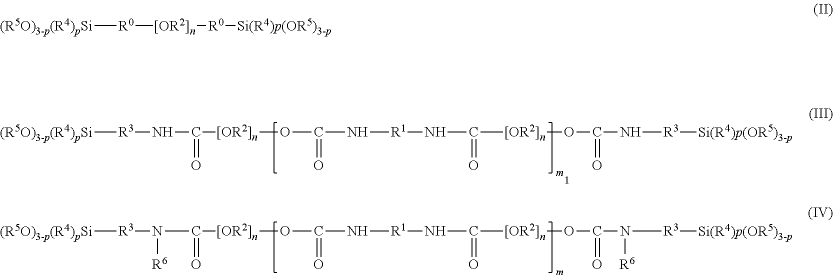
wherein:
R¹ represents a divalent hydrocarbon-based radical comprising from 5 to 15 carbon atoms which can be aromatic or aliphatic and linear, branched or cyclic,
R⁰ represents a linear or branched divalent alkylene radical comprising from 3 to 6 carbon atoms,
R³ represents a linear or branched divalent alkylene radical comprising from 1 to 6 carbon atoms,
R² represents a linear or branched divalent alkylene radical comprising from 2 to 14 carbon atoms,
R⁴ represents a linear or branched alkyl radical comprising from 1 to 4 carbon atoms, or an alkoxy group comprising from 1 to 4 carbon atoms;
R⁵ represents a linear or branched alkyl radical comprising from 1 to 4 carbon atoms or a group —N═C(Rⁱ)R^{j}, wherein:
Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical; or
Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom, said nitrogen atom then not being bonded to a hydrogen atom;
R⁶ represents a hydrogen atom, a phenyl radical, a linear, branched or cyclic alkyl radical comprising from 1 to 6 carbon atoms, or a 2-succinate radical of formula: 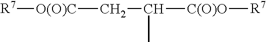
wherein R⁷ is a linear or branched alkyl radical comprising from 1 to 6 carbon atoms,
n is an integer such that the number-average molecular weight of the polyether block of formula —[OR²]ₙ— ranges from 300 g/mol to 40 000 g/mol in the polymers of formulae (II), (III) and (IV),
m₁ is zero or an integer,
n and m₁ are such that the number-average molecular weight of the polymer of formula (III) ranges from 500 g/mol to 50,000 g/mol,
m is an integer other than zero,
n and m are such that the number-average molecular weight of the polymer of formula (IV) ranges from 500 g/mol to 50 000 g/mol, and
p is an integer equal to 0, 1 or 2.

20. The composition as claimed in claim 17, wherein the polymer (A) is selected from the group consisting of the polymers of formula (II):
(R⁵O)₃₋ₚ(R⁴)ₚSi—R⁰—[OR²]ₙ—R⁰—Si(R⁴)p(OR⁵)₃₋ₚ (II)
wherein:
R⁰ represents a linear or branched divalent alkylene radical comprising from 3 to 6 carbon atoms,
R² represents a linear or branched divalent alkylene radical comprising from 2 to 14 carbon atoms,
R⁴ represents a linear or branched alkyl radical comprising from 1 to 4 carbon atoms, or analkoxy group comprising from 1 to 4 carbon atoms;
R⁵ represents a linear or branched alkyl radical comprising from 1 to 4 carbon atoms or a group —N═C(Rⁱ)R^{j}, wherein:
Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical; or
Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms chosen from an oxygen atom, a sulfur atom or a nitrogen atom,
said nitrogen atom then not being bonded to a hydrogen atom; and
— p is an integer equal to 0, 1 or 2.

21. The composition as claimed in claim 17, wherein it comprises from 3% to 80% by weight of silylated polymer(s) (A) relative to the total weight of said composition.

22. The composition as claimed in claim 17, wherein the bis(alkoxysilane) or tri(alkoxysilane) (C) has the following formula (V):
R⁸—[SIR⁹ₜ(OR¹⁰)₃₋ₜ]₅ (V)
wherein:
t represents an integer equal to 0, 1 or 2;
s represents an integer equal to 2 or 3;
R⁸ represents an organic radical;
R⁹, which may be identical or different, each represent a linear or branched C₁-C₆ alkyl group, or an —OR¹¹ group with R¹¹ representing a linear or branched C₁-C₄ alkyl group;
R¹⁰, which may be identical or different, each represent a linear or branched alkyl radical comprising from 1 to 4 carbon atoms or an —N═C(Rⁱ)R^{j} group wherein:
Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical; or
Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom.

23. The composition as claimed in claim 17, wherein the bis(alkoxysilane) or tri(alkoxysilane) (C) has a molar mass ranging from 270 to 1000 g/mol.

24. The composition as claimed in claim 17, wherein the bis(alkoxysilane) or tri(alkoxysilane) (C) has either of the following formulae (V-A) or (V-B):
(R¹⁰O)₃₋ₜR⁹ₜSi—R¹²—SiR⁹ₜ(OR¹⁰)₃₋ₜ (V-A)
R¹³—[SiR⁹ₜ(OR¹⁰)₃₋ₜ]₃ (V-B)
wherein:
t represents an integer equal to 0, 1 or 2;
R⁹, which may be identical or different, each represent a linear or branched C₁-C₆ alkyl group, or an —OR¹¹ group with R¹¹ representing a linear or branched C₁-C₄ alkyl group;
R¹⁰, which may be identical or different, each represent a linear or branched alkyl radical comprising from 1 to 4 carbon atoms or an —N═C(Rⁱ)R^{j} group wherein:
Rⁱ is a radical chosen from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
R^{j} is a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical; or
Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom.
R¹² represents an oxygen atom, a linear or branched C₁-C₁₂ alkylene radical, a C₆-C₁₂ arylene radical, or a linear or branched C₂-C₁₂ alkenylene radical, said alkylene and alkenylene radicals optionally comprising one or more radicals chosen from —O—, —S—, —NR— with R representing H or a group that is alkyl, —C(═O)—O— or —O—C(═O), —C(O)—NR′— or —NR′—C(═O) with R′ representing H or a group that is alkyl, —O—C(═O)—NH— or —NH—C(═O)—O— or uretdione;
R¹³ represents a radical: 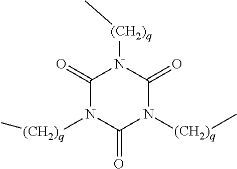
with q representing an integer ranging from 1 to 10.

25. The composition as claimed in claim 24, wherein the compounds of formula (V-B) are selected from the group consisting of the following compounds:

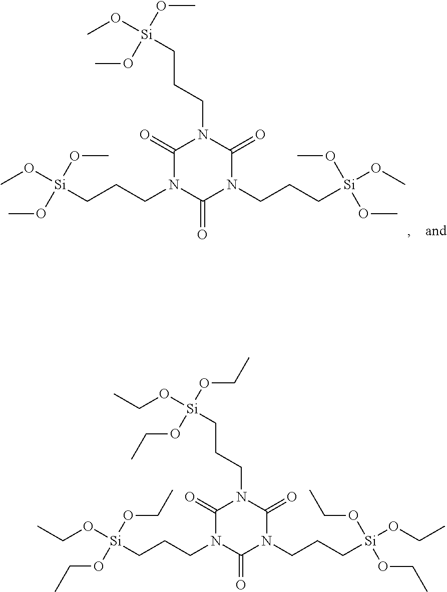

26. The composition as claimed in claim 24, wherein the compounds of formula (V-A) are selected from the group consisting of the following compounds:

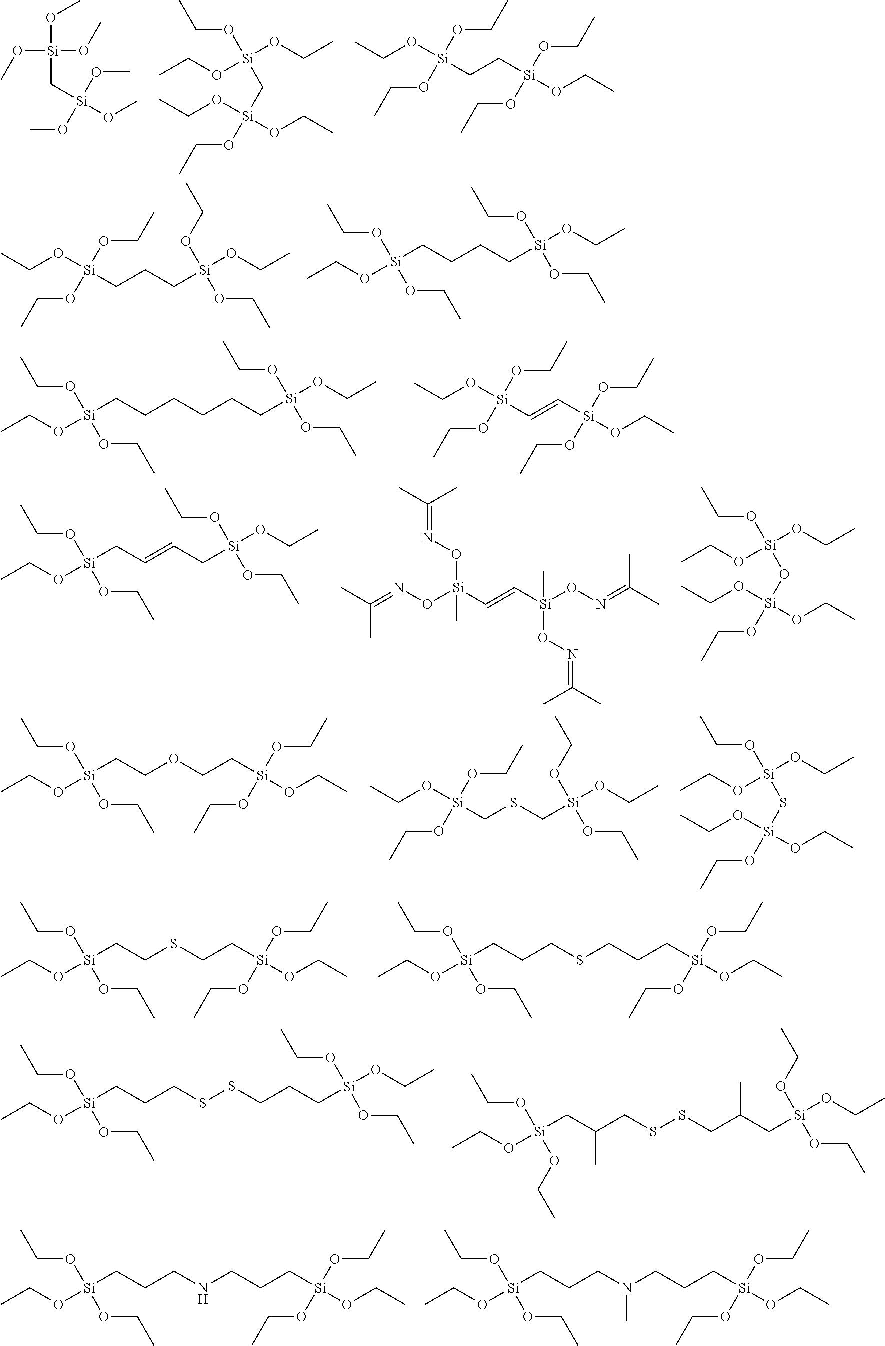

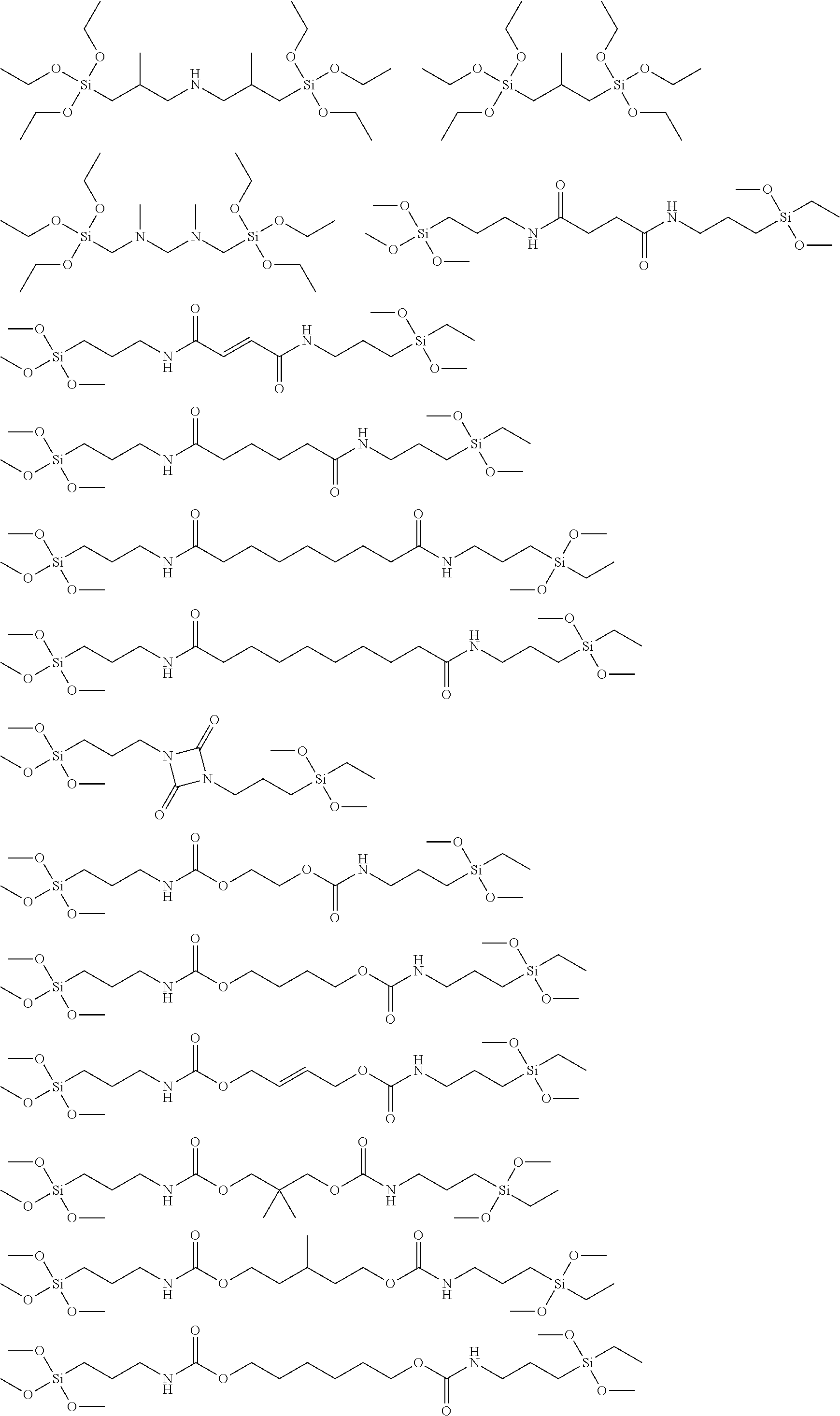

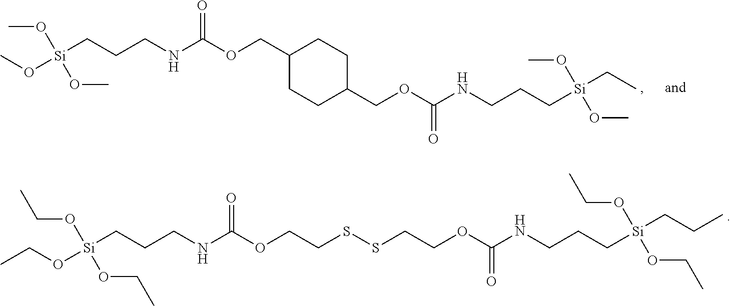

27. The composition as claimed in claim 17, wherein it comprises a total content of bis(alkoxysilane)(s) or tri(alkoxysilane)(s) (C) ranging from 0.1% to 20% by weight, relative to the total weight of the composition.

28. The composition as claimed in claim 17, wherein the carbonate filler is selected from the group consisting of alkali metal or alkaline earth metal carbonates and mixtures thereof.

29. The composition as claimed in claim 17, wherein it comprises:
from 10% to 60% by weight of polymer(s) (A) comprising at least one alkoxysilane group;
from 25% to 70% by weight of carbonate filler(s) (B);
from 0.01% to 5% by weight of bis(alkoxysilane)(s) or tri(alkoxysilane)(s) (C) having a molar mass ranging from 250 to 1000 g/mol; and
from 0.01% to 1% by weight of crosslinking catalyst(s) (D);
the percentages being expressed by weight relative to the total weight of said composition.

30. The composition as claimed in claim 17, wherein it comprises at least one additive selected from the group consisting of solvents, pigments, adhesion promoters, moisture absorbers, UV stabilizers, rheological agents, fillers other than carbonate fillers, and mixtures thereof.

31. An adhesive, sealant or coating comprising the composition as claimed in claim 17.

32. A method for improving resistance to aging of a composition after crosslinking, the method comprising adding to a composition a compound (C) comprising bis(alkoxysilane)s and tri(alkoxysilane)s having a molar mass ranging from 250 to 1000 g/mol, wherein the composition comprises:
at least one polymer (A) comprising at least one alkoxysilane group; and
at least 25% by weight of a carbonate filler (B) relative to the total weight of said composition.
